(19) United States
(12) Patent Application Publication
(10) Pub. No.: US 2025/0165014 A1
(43) Pub. Date: May 22, 2025

(54) Control method of feeding weight of plastic particles based on speed regulating motor and weight feedback

(71) Applicant: Motan Holding GmbH, Konstanz (DE)

(72) Inventor: Logan JIANG, Taicang City (CN)

(73) Assignee: Motan Holding GmbH, Konstanz (DE)

(21) Appl. No.: 18/869,947

(22) PCT Filed: May 30, 2023
(86) PCT No.: PCT/EP2023/000030

§ 371 Date: Nov. 27, 2024

(30) Foreign Application Priority Data
May 31, 2022 (CN) 202210608919.3

(51) Int. Cl. G05D 13/62; B29B 7/24; B29B 7/28

(52) U.S. Cl. CPC G05D 13/62; B29B 7/242; B29B 7/283

(57) ABSTRACT

A control method of feeding weight of plastic particles based on speed regulating motor and weight feedback is characterized in that it includes a central processor (71), which is electrically connected to a motor controller (72), and the motor controller (72) drives a actuator (73) to drive a controlled object (74) to complete an operation, so that a mixing bin (4) outputs the corresponding amount of materials, and characterized in that a detection device (75) is set on the controlled object (74), and the detection device (75) is communicated with the central processor (71).

### CROSS-REFERENCE TO RELATED APPLICATION

This application is a national stage application, filed under 35 U.S.C. § 371, of International Patent Application PCT/EP2023/000030, filed on May 30, 2023, which claims the benefit of Chinese Patent Application CN 202210608919.3, filed on May 31, 2022.

### TECHNICAL FIELD

The disclosure belongs to the technical field of material mixing application in the production process of plastic products, in particular to a method for controlling the feeding weight of plastic particles based on a speed regulating motor and weight feedback.

### BACKGROUND

In material mixing applications, mixers often need to mix multiple materials. Each kind of material is fed according to the preset proportion, loaded in batches, put into the mixing bin, and start the mixing paddle to mix the materials in the cavity evenly. After the materials in the mixing bin accumulate to a certain height, the next mixing batch starts again after the uniformly mixed materials are discharged. At present, the feeding control mode mainly adopts volumetric feeding and weighing feeding.

Volumetric feeding control, the plastic particles are given by the actuator (in the form of motor and screw or cylinder and valve). The feeding weight is mainly calculated by the motor speed, screw size or valve switch size to calculate the weight that can be blanking or discharging in each unit time. Generally, the unit is second, and the grams of discharging per second are calculated, corresponding to the grams per second. Then, the actual weight of blanking is indirectly controlled by controlling the operating time of the actuator. It is an open loop control system without weight feedback.

Weighing type feeding control is a closed loop control system with weight feedback, which adds a weighing feedback module compared with volumetric feeding. The plastic particles are fed into the weighing container by the motor driven screw. The weighing module collects the weight of the plastic particles in the container and feeds it back to the control controller. The controller calculates the difference between the current weight and the target weight, and then starts and stops the motor to control the actual weight of blanking. Compared with volumetric type, it can control the weight of blanking more accurately.

However, the motor is unable to adjust the speed and the speed setting is difficult. When the motor is shut down, due to the effect of inertia, if the speed is too high, the actual weight will easily exceed the set weight. if the speed is too low, although the inertial effect is small, the extended running time will lead to reduced output.

Moreover, the precision of each batch is not high. A batch generally consists of 2 to 3 materials, and the proportion of a batch will be affected by the weight of each material in the batch. After the motor stops, because there is still a distance between the material from the hopper outlet to the weighing hopper, it is necessary to stop the motor in advance. The length of time for stopping the motor in advance is generally set to a fixed value, However, in the actual operation process, the weight of the material falling from the hopper outlet to the weighing hopper is affected by various factors (bulk density, material characteristics, blanking type, etc.), which will change rather than a fixed value. The deviation in the weight of single component blanking will affect the overall proportion of the whole batch, which is not applicable to the occasions with high precision requirements.

There are several drawbacks in the prior art:

The control precision with the volumetric feeding control is not high, and it is easy to be disturbed by the bulk density of materials. The blanking weight cannot be accurately controlled. For some special materials such as electrostatic materials, the actual blanking weight error is greater.

As for the weighing type feeding control the motor cannot be adjusted, and the speed setting is difficult. Due to the inertia when the motor is stopped, if the speed is too high, the actual weight may exceed the set weight when the motor is stopped. If the speed is too low, although the inertial effect is small, the extended running time will lead to reduced output.

The proportion precision of each batch is not high. A batch generally consists of 2 to 3 materials, and the proportion of a batch will be affected by the weight of each material in the batch. After the motor stops, because there is still a distance between the material from the hopper outlet to the weighing hopper, it is necessary to stop the motor in advance. The length of time for stopping the motor in advance is generally set to a fixed value, However, in the actual operation process, the weight of the material falling from the hopper outlet to the weighing hopper is affected by various factors (bulk density, material characteristics, blanking type, etc.), which will change rather than a fixed value. The deviation in the weight of single component blanking will affect the overall proportion of the whole batch, which is not applicable to the occasions with high precision requirements.

It should be noted that the above contents belong to the inventor's technical cognition and do not necessarily constitute the existing technology.

Therefore the invention aims to solve the following technical problems: The problem of batch precision control of plastic particle mixer, the influence of inertia on blanking weight when the motor is stopped, the problem that the advance of motor shutdown cannot be corrected and the problem of low feeding efficiency under the condition of ensuring accuracy.

### SUMMARY

In order to solve the above problems, the invention aims to provide a control method for the feeding weight of plastic particles based on a speed regulating motor and weight feedback.

In order to achieve the above purpose, the invention proposes a control method for the feeding weight of plastic particles based on a speed regulating motor and weight feedback, which is characterized in that it includes a central processor, which is electrically connected with a motor controller, the motor controller drives the actuator to drive the controlled object to complete the operation, so that the mixing bin outputs the corresponding amount of materials, and a detection device is arranged on the controlled object. The detection device is communicated with the central processor.

Preferably, the central processing unit and the motor controller constitute a controller unit. By collecting feedback real-time weight and calculating and controlling the controller unit, the motor controller is a driver, the actuator is a speed regulating motor, and the blanking or discharging speed can be adjusted. The controlled object is a screw, the speed regulating motor is connected to the driver, and the detection device is a weighing sensor. The weight of blanking can be measured in real time through the weighing sensor.

Advantageously, the controller unit controls the speed regulating motor by using the method of multi segment speed, feeds back to the controller unit according to the weighing value, and the controller unit controls the speed regulating motor to run at high speed first to ensure the output. When the weight is close to the set weight, change the speed of the speed regulating motor to make it run at low speed to ensure the control accuracy.

In an example, on the basis of multi segment speed control, multiple advance quantities are used to improve the control accuracy. The first advance quantity is used to trigger the deceleration of the speed regulating motor, so that the speed regulating motor can enter the low speed operation state, avoiding huge inertia caused by direct shutdown at high speed. When the low-speed speed regulating motor reaches the target weight, there will be a certain delay by using the residual inertia and the distance between the blanking port and the weighing container. The weight of this distance needs to be predicted by the second advance, so the second advance is set to judge the downtime. The control accuracy is improved on the basis of the multi speed control by controlling the two advance quantities.

In an example, the advance method is set by automatic calculation and correction to ensure that the control accuracy reaches the expected set value. The advance of the first section is automatically set according to the batch weight and proportion. The advance of the second section is different due to the impact of the material nature, screw size, motor speed and other factors after the shutdown in the actual operation process, so the advance of the second section needs to be adjusted. During operation, the advance of the second section will be corrected in real time by calculating the average deviation to ensure the control accuracy.

In an example, the method serves for operating a plant for mixing material, in particular plastic particles. The plant includes a material supply, a conveyor system, a weighing system, a central processor unit with a data storage and a computer unit. The data storage serves especially for the recording of a predetermined target weight, a first advance value and a second advance value. The computer unit especially performs differentiation and value comparisons. The method comprises the following steps:
a) weighing an output of the conveying device,
b) forming a difference between the target weight and the actual weight received from step a),
c) comparing the difference value with the first advance value,
d) operating the conveyor system at a first speed if the difference value of step c) exceeds the first advance value, or
e) operating the conveyor system at a second speed if the difference value of step c) falls below the first advance value and exceeds the second advance value, and
f) stopping the conveyor system if the difference value of step c) falls below the second advance value.

The central processor unit receives actual data from the weighing unit, subtracts it from the predefined target value, compares the result of the difference with at least one advance value and controls a speed of the conveyor system depending on the result of the comparison.

A plant for mixing material, in particular plastic particles, comprises a material supply, a conveyor system, a weighing system, a central processor unit with a data storage, a computer unit and a motor driver. The data storage serves especially for the recording of a predetermined target weight, of a predetermined first advance value and of at least a predetermined second advance value. The computer unit especially is able to perform differentiation and value comparison. The central processor unit comprises a difference unit, a comparison unit and a control unit.

The difference unit forms a difference from a currently detected weight of the weighing unit and the predetermined target value. Then the comparison unit compares the difference with at least one advance value. Afterwards the control unit controls a speed of the conveyor system depending on the result of the comparison. The plant therefore especially performs one of the above-described methods of the plastic particle feeding weight based on the speed regulating motor and weight feedback.

The control method of the plastic particle feeding weight based on the speed regulating motor and weight feedback proposed by the invention can bring the following beneficial effects:
1. Intelligent controller and multiple advance control algorithms are adopted to ensure the accuracy of batch weight. The controller can be established based on SIEMENS S7-200 SMART. The algorithms can be programmed for example by software SIEMENS STEP 7-MicroWIN SMART V2.7.
2. Adopt weighing feedback and real-time calculation of controller to realize closed-loop control and improve the control accuracy of the system.
3. Multi stage speed control of speed regulating motor is adopted to ensure accuracy without affecting output. The first stage can be the high-speed stage, to ensure the high-speed dosing. The second stage can be the low-speed stage, to ensure the final precision. Further stages between the above first and second stages could be defined to improve the accuracy of the described method. Multiple settings of advance can be set to switch the stages.

The following technical effects are achieved by the invention:
There is weighing feedback in the system, which adopts closed loop control with high control accuracy.
Multi-stage speed and advance control ensure stable output, improve control accuracy, and ensure product quality and output.
It adopts automatic setting and automatic correction of advance amount, which is convenient to operate without manual setting, stable control, and reduces personnel costs.

### BRIEF DESCRIPTION OF THE DRAWINGS

The accompanying drawings described herein are used to provide a further understanding of the invention. The schematic embodiments and their descriptions of the invention are used to explain the invention, and do not constitute an improper limitation of the invention. In the attached drawing:

FIG. 1 is a first schematic diagram of the system structure of the prior art (volume control type),

FIG. 2 is a second schematic diagram of the system structure of the prior art (weighing control type),

FIG. 3 is a principle diagram of a material mixing plant,

FIG. 4 is a detail enlargement from FIG. 3, and

FIGS. 5, 6 are schematic diagrams of the control principle structure of the disclosure.

### DETAILED DESCRIPTION

In order to explain more clearly the overall concept of the invention, the following is a detailed description by way of example in combination with the drawings of the specification.

In the description of the invention, it should be understood that the terms “center”, “top”, “bottom”, “front”, “back”, “left”, “right”, “vertical”, “horizontal”, “top”, “bottom”, “inside”, “outside”, “axial”, “radial”, “circumferential” and other directions or positional relationships indicated are based on the directions or positional relationships shown in the drawings, which are only for the convenience of describing the invention and simplifying the description, rather than indicating or implying that the device or element referred to must have a specific orientation, be constructed and operate in a specific orientation, it cannot be understood as a limitation of the invention.

In addition, the terms “first” and “second” only are used for description purposes and cannot be understood as indicating or implying relative importance or implicitly indicating the number of indicated technical features. Thus, the features defined as “first” and “second” can explicitly or implicitly include one or more of these features. In the description of the invention, “multiple” means two or more, unless otherwise specifically defined.

In the invention, unless otherwise specified and defined, the terms “installation”, “connection”, “connection”, “fixed” and other terms should be understood in a broad sense, for example, they can be fixed connection, removable connection, or integrated; It can be mechanical connection, electrical connection or communication; It can be directly connected or indirectly connected through intermediate media. It can be the internal connection of two components or the interaction between two components. For ordinary technicians in the art, the specific meaning of the above terms in the invention can be understood according to specific situations.

In the present invention, unless otherwise specified and defined, the first feature “above” or “below” the second feature can be the direct contact between the first and second features, or the indirect contact between the first and second features through an intermediate medium. In the description of this specification, reference to the description of the terms “one scheme”, “some schemes”, “example”, “specific example”, or “some examples” means that the specific features, structures, materials or features described in combination with the scheme or examples are included in at least one scheme or example of the invention. In this specification, the schematic expressions of the above terms do not have to refer to the same scheme or example. Moreover, the described specific features, structures, materials or characteristics may be combined in an appropriate manner in any one or more schemes or examples.

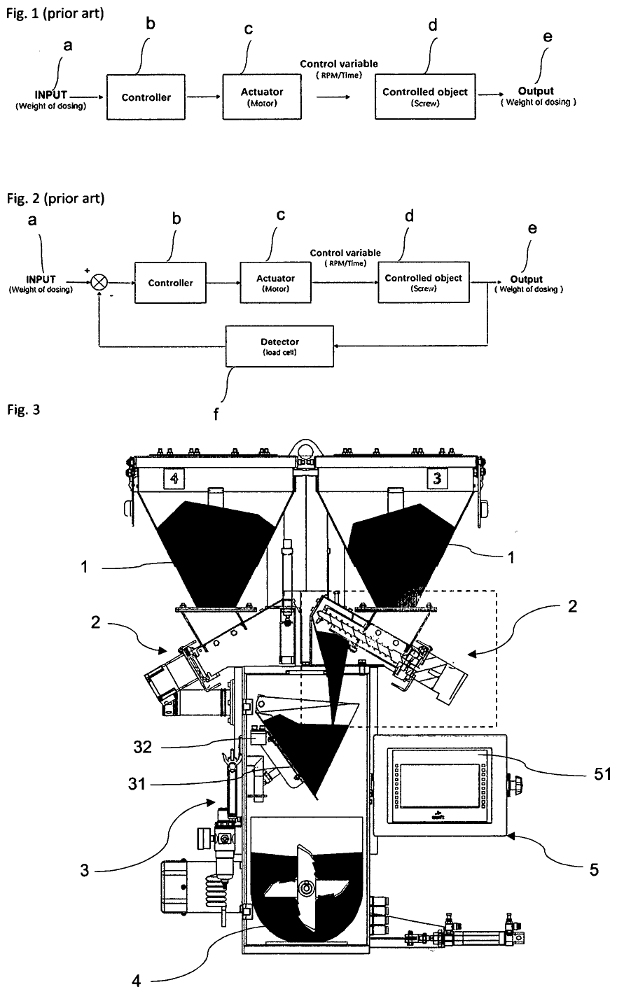

FIGS. 1 and 2 now show the system structure of the two main control modes in the current market. FIG. 1 concerns the volume control method: between an input a and an output e, the system comprises a controller b, an actuator c, i.e. a motor of a conveyor, and a controlled object d, namely the screw of a screw feeder. The screw feeder conveys the plastic granules at a fixed speed. The dosing weight of the plastic granules therefore is essentially calculated by the motor speed and the screw size. This is used to determine the weight that is conveyed per unit of time. The unit usually used is grams per second. The actual weight of the feed is indirectly controlled by controlling the operating time of the actuator c.

The controller b is electrically connected to the actuator c, which drives the controlled object d to deliver the plastic particles at the output e.

FIG. 2 depicts the weighing control method: the according system comprises additionally to the system shown in FIG. 1 a detector f, for example a load cell. The detector f is connected with the input a and the output side e of the system. The weighing control method therefore is a closed loop control system with weight feedback, which adds a weighing feedback module compared with volumetric dosing. The plastic granules are dosed into a weighing container by the motor driven screw d conveying at a fixed speed. The weighing module collects the weight of the plastic granules in the container and feeds it back to the controller b. The controller b calculates the difference between the current weight and the target weight, and then starts and stops the motor c to control the actual weight of output. Compared with volumetric type, it can control the weight of output more accurately.

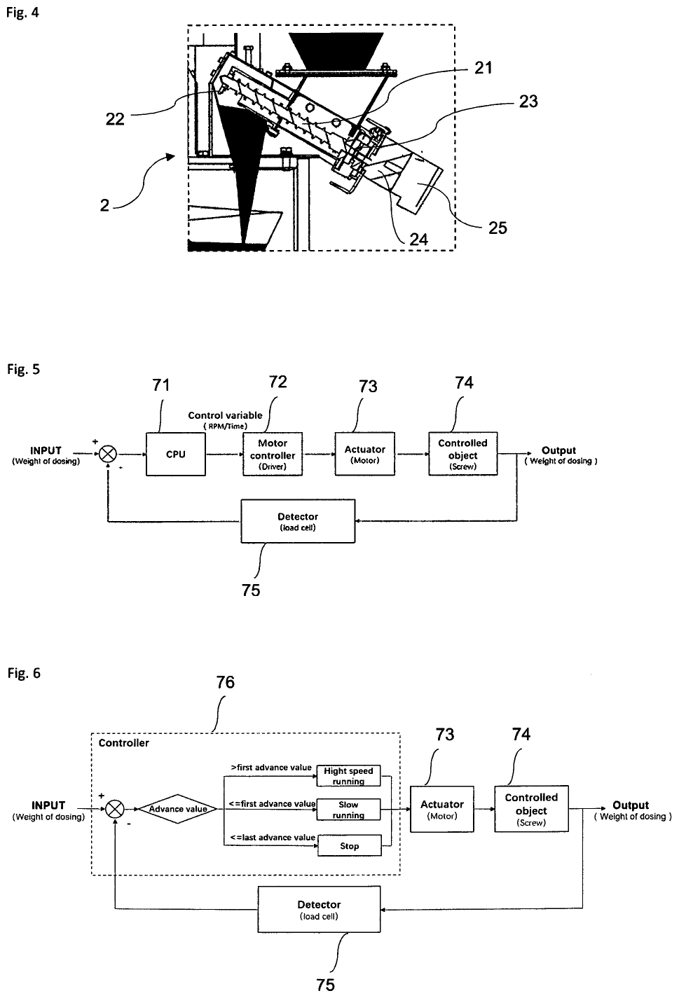

FIGS. 3 to 4 show the principle diagram of a material mixing plant. The material mixing plant has two material hoppers 1, featuring an input of a material mixing application. A dosing mechanism 2 is mounted downstream of each material hopper 1. Each dosing mechanism 2 has a dosing screw 21, a screw sleeve 22, a coupling 23, a gear box 24 and a dosing motor 25 (FIG. 4). The dosing motor 25 drives the dosing screw 21 via the gear in the gear box 24 and the coupling 23 and is installed on the dosing mechanism.

Both dosing units 2 lead into a weighing module 3. The weighing module 3 comprises a weighing chamber or weighing container 31 and a weighing sensor or load cell 32. Downstream the weighing module 3 there is a mixing hopper 4 for further processing of the plastic granules, featuring an output of the material mixing application. Finally, the material mixing plant has a main controller 5 with a human-machine interface 51.

The motor 25 is connected to a driver (not shown), connected to the main controller 5 through a communication cable. The weighing chamber 31 is equipped with the load cell 32, which is part of the weighing module 3. It is connected to the main controller 5 through a communication cable.

A power module (not shown) is installed to supply power to the main controller 5, weighing module 3, motor driver and human-machine interface 51. There is a logic operation program, driver control program, weighing module communication control, etc. installed for the controller 5. A human-computer interface is connected to the main controller 5 through a communication cable and using an interface program for installing operation control for human-machine interface 51.

A control of the main controller 5 serves to set a communication address and parameters between the weighing module 3 and the motor driver through the human-computer interface to connect it with the main controller 5.

Another control of the main controller 5 serves to collect the real-time weight of the material in the weighing bin or chamber 31 weighed by the weighing module 3 through the human-machine interface.

After setting the blanking or dosing parameters on the human-machine interface, the parameters are sent to the motor driver and weighing module 3 through the main controller 5.

By starting the main controller 5 through the human-computer interface and running the algorithm program, the main controller 5 then controls the driver to automatically control the motor speed and start and stop according to the dosing parameters, and collect and feedback the material weight in the weighing bin 31 in real time to achieve accurate control.

As shown in FIGS. 5 and 6, the embodiment of the invention proposes a control method for the feeding weight of plastic particles based on a speed regulating motor and weight feedback. It includes a central processor unit (CPU) 71 contained in the main controller 5 of FIG. 3. The central processor 71 is electrically connected to a motor controller 72. The motor controller 72 drives an actuator 73, to drive a controlled object 74 to complete the operation, so that the mixing bin outputs the corresponding amount of materials. The controlled object 74 is provided with a detection device 75. The detection device 75 is communicated with the central processor 71.

Specifically, the central processor 71 and the motor controller 72 form a controller unit 76 (FIG. 6), which collects the feedback real-time weight and controls the controller 72 through calculation. The motor controller 72 is the driver (not shown) of the motor 25 of FIG. 3, 4, and the actuator 73 is the speed regulating motor 25 (FIG. 3 to 4), which can adjust the dosing speed. The controlled object 74 is the the dosing mechanism 2, especially the screw 21. The speed regulating motor 25 is connected to the driver resp. the motor controller 72, and the detection device 75 is the weighing module 3, especially the weighing sensor 32, through which the dosing weight can be measured in real time.

Specifically, the controller unit 76 controls the speed regulating motor 25 by using the method of multi segment speed. According to the feedback of the weighing value to the controller unit 76, the controller unit 76 controls the speed regulating motor 25 to run at a high speed first to ensure the output. When the weight is close to the set weight, it changes the speed of the speed regulating motor 25 to make it run at a low speed to ensure the control accuracy.

Specifically, on the basis of multi segment speed control, multiple advance quantities are used to improve the control accuracy. The first advance quantity is used to trigger the deceleration of the speed regulating motor 25, so that the speed regulating motor 25 can enter the low-speed operation state, avoiding the huge inertia caused by the direct shutdown from the high-speed state. When the speed regulating motor 25 in the low-speed operation state reaches the target weight, there will be a certain delay by using the residual inertia and the distance between the blanking port and the weighing container 31. The second advance is required to predict the weight of this distance, so the second advance is set to judge the downtime. The control accuracy is improved on the basis of multi segment speed control through the control of two cash withdrawals.

Specifically, the advance method is set by automatic calculation and correction to ensure that the control accuracy reaches the expected set value. The advance of the first segment is automatically set according to the batch weight and proportion. The advance of the second segment is different due to the nature of materials, screw size, motor speed and other factors after the shutdown in the actual operation process, so the advance of the second segment needs to be adjusted. During operation, the advance of the second section will be corrected in real time by calculating the average deviation to ensure the control accuracy.

In the following, the control principle structure of the invention will be described as an example:

First of all the advance values for changing first stage and second stage are set, called first advance value & second advance value. The first advance value for example is 10 g (the first advance value will be corrected by continuous dosing), the second advance value e.g. is 3 g (this value will be corrected by continuous dosing either).

Then the controller 76 gets a target dosing weight from recipe 31, e.g. 50 g, and batch weight settings (INPUT, weight of dosing). The controller 76 gets the actual weight from the detector (load cell 32) in real time. The controller 76 calculates with the actual weight and target weight, to get residual dosing weight.

Residual dosing weight=Target weight−Actual weight

Then the controller 76 compares the residual dosing weight and advance values to control the running stage of the actuator (motor 25). The screw 21 is connected by the gearbox 24 and the coupling 23 with the motor 25. If the motor 25 is running, then the screw 21 is dosing material from material hopper 1 to weight hopper 31.

If e.g. the actual weight is lower than 40 g, this means the residual dosing weight is larger than first advance value of 10 g, then the motor 25 will be set with high speed, for example at 3000 rpm. The load cell 32 detects the actual weight and feedbacks to controller 76 in real time.

If the actual weight lies e.g. between 41 g and 47 g, which means the residual dosing weight is lower than first advance value (10 g), then the motor 25 will be set with low speed of 100 rpm for example. The load cell 32 detects the actual weight and feedbacks to controller 76 in real time.

If the actual weight is larger than 47 g equivalent to the residual dosing weight is lower than second advance value of 3 g, then the motor 25 will be stopped. The load cell 32 detects the actual weight and feedbacks to controller 76 in real time.

After some delay for stability of weighing the controller 76 records the actual weight as dosed weight.

The dosing speed can be adjusted by using the speed regulating motor 25. The load cell 32 and a transmitter are used to measure the weight of dosing in real time. The central processing unit 71 is used to collect the real-time weight feedback and control the motor 25 by calculation.

The motor 25 is controlled by the method of multi-stage speed. According to the feedback of the weighing value to the controller 76, the controller 76 controls the motor 25 to run at high speed first to ensure the output. When the weight is close to the set weight, the controller 76 changes the speed of the motor 25, and use low speed to ensure the control accuracy.

On the basis of multi-stage speed control, the control accuracy is improved by using the method of multiple advance values. If the motor 25 runs at a high speed and stops directly, it will produce a large stopping inertia. If the motor is switched to a low speed and then stopped, the stopping inertia can be reduced. Therefore, the advance of the first stage is used to trigger the motor deceleration, so that the motor 25 can enter the low speed operation state, thus avoiding the large inertia caused by the direct shutdown at the high-speed state. At the same time, because the speed of the first stage is fast, the feeding is fast, so the output is increased. When the low-speed motor reaches the target weight, there will be a certain delay by using the residual inertia and the distance between the dosing outlet and the weighing hopper 31. Therefore, the second advance is required to predict the weight of this distance, so the second advance is set to judge the shutdown. The control precision is improved on the basis of multi-stage speed control by controlling two advance values.

The method of automatic calculation and correction is adopted to set the advance to ensure that the control accuracy reaches the expected set value. The advance of a stage is automatically set according to the batch weight and proportion. The second stage advance is different because the type of materials falling in this distance after the shutdown in the actual operation process will be affected by the material properties, screw size, motor speed and other factors, so this second stage advance needs to be adjusted. During operation, the method of calculating the average deviation will modify the advance of the two segments in real time to ensure the control accuracy.

Each embodiment in this specification is described in a progressive manner. The same and similar parts of each embodiment can be referred to each other. Each embodiment focuses on the differences with other embodiments. In particular, for the system embodiment, since it is basically similar to the method embodiment, the description is relatively simple. For details refer to the partial description of the method embodiment.

The above is only an embodiment of the invention and is not intended to limit the invention. For those skilled in the art, the invention can have various changes and variations. Any modification, equivalent replacement, improvement, etc. made within the spirit and principle of the invention shall be included in the scope of claims of the invention.

1. A control method of feeding weight of plastic particles based on speed regulating motor and weight feedback,
characterized in that it includes a central processor (71), which is electrically connected to a motor controller (72), and the motor controller (72) drives an actuator (73) to drive a controlled object (74) to complete an operation, so that a mixing bin (4) outputs the corresponding amount of materials, and
characterized in that a detection device (75) is set on the controlled object (74), and the detection device (75) is communicated with the central processor (71).

2. The control method for the feeding weight of plastic particles based on a speed regulating motor and weight feedback according to claim 1, wherein
the central processing unit (71) and the motor controller (72) constitute a controller unit (76), and
the motor controller (72) can be controlled by calculating and calculating the feedback real-time weight at the same time, and
the motor controller (72) is a driver, and
the actuator (73) is a speed regulating motor (25), and
the blanking speed can be adjusted, and
the controlled object is a screw (21),
the speed regulating motor (25) is connected with the driver (72), and
the detection device is at least one weighing sensor (32) through which the weight of blanking can be measured in real time.

3. The control method for feeding weight of plastic particles based on a speed regulating motor and weight feedback according to claim 1, wherein
the controller unit (76) controls the speed regulating motor (25) by using a multi segment speed method, feeds back to the controller unit (76) according to the weighing value, and
the controller unit (76) controls the speed regulating motor (25) to run at a high speed first, when the weight is close to the set weight, changes the speed of the speed regulating motor (25) and runs it at low speed.

4. The control method for the feeding weight of plastic particles based on a speed regulating motor and weight feedback according to claim 1,
wherein the control accuracy is improved by using a method of multiple advance amounts on the basis of multi segment speed control,
wherein the first advance amount is used to trigger the deceleration of the speed regulating motor (25), so that the speed regulating motor (25) can enter a low speed operation state, avoiding huge inertia caused by direct shutdown from a high speed state, when the low-speed speed regulating motor (25) reaches the target weight, there will be a certain delay by using the residual inertia and the distance between the blanking port and the weighing container (4), and
wherein the second segment advance will prejudge the weight of this distance to judge the downtime.

5. The control method for feeding weight of plastic particles based on speed regulating motor and weight feedback according to claim 1,
wherein the method of advance is set by automatic calculation and correction to ensure that the control accuracy reaches the expected set value,
wherein the first segment advance is set automatically according to the batch weight and proportion, and
wherein the second segment advance is corrected in real time by calculating the average deviation.

6. A method for operating a plant for mixing material, the plant including a material supply (1), a conveyor system (2, 74), a weighing system (3, 75), a central processor unit (5) with a data storage and a computer unit, the data storage especially for the recording of a target weight, a first advance value and a second advance value, the computer unit especially for performing differentiation and value comparison, the method comprising the following steps:
a) weighing an output of the conveying device (2),
b) forming a difference between the target weight and the actual weight received from step a),
c) comparing the difference value with the first advance value,
d) operating the conveyor system (2) at a first speed if the difference value of step c) exceeds the first advance value, or
e) operating the conveyor system (2) at a second speed if the difference value of step c) falls below the first advance value and exceeds the second advance value, and
f) stopping the conveyor system (2) if the difference value of step c) falls below the second advance value.

7. A plant for mixing material, comprising:
a material supply (1),
a conveyor system (2, 74),
a weighing system (3, 75),
a central processor unit (5, 71) with a data storage,
a computer unit and a motor driver (72), the data storage especially for the recording of a target weight,
a first advance value and at least a second advance value, the computer unit especially for performing differentiation and value comparison,
wherein the central processor unit (5) comprises a difference unit that forms a difference from a currently detected weight of the weighing unit (2) and the predefined target value,
a comparison unit that compares the difference with at least one advance value, and a control unit that controls a speed of the conveyor system (2, 74) depending on the result of the comparison,
wherein the plant is configured for performing the method according to claim 6.
